(19) United States
(12) Patent Application Publication
(10) Pub. No.: US 2009/0223183 A1
(43) Pub. Date: Sep. 10, 2009

(54) Vacuum collector having sweeping device

(75) Inventor: Kun Yi Lin, Taichung (TW)

Correspondence Address: CHARLES E. BAXLEY, ESQUIRE, 90 JOHN STREET, SUITE 309, NEW YORK, NY, 10038, US

(73) Assignee: Chang Tjer Industrial Co., Ltd.

(21) Appl. No.: 12/074,605

(22) Filed: Mar. 4, 2008

(51) Int. Cl. B01D 46/04; B01D 41/00; A47L 9/10

(52) U.S. Cl. 55/296; 15/352

(57) ABSTRACT

A vacuum collector includes a filter canister disposed below a housing, a filter member disposed in the filter canister, a dust removing device disposed in the filter member and driven by a driving device for sweeping dust from the filter member, a dust collecting receptacle disposed below the housing, a fan device disposed in the housing for drawing air and dust into the housing and for collecting particles in the dust collecting receptacle, and a vacuum motor coupled to the fan device for drawing the air and the dust into the housing automatically. A control device may be coupled to the driving device and the vacuum motor for selectively or automatically operating the driving device and the vacuum motor.

### BACKGROUND OF THE INVENTION

1. Field of the Invention

The present invention relates to a vacuum collector, and more particularly to a vacuum collector having a stirring or sweeping device disposed in a screen filter member and operated with a separated motor for sweeping dirt from the screen filter member and for allowing the dirt or the ash to be easily and automatically collected.

2. Description of the Prior Art

Typical vacuum collectors comprise a duct arm or a trunk for directing toward the dust or dirt or fume to be collected, an electric vacuum motor or pump for vacuuming or drawing the dust or dirt or fume into or through the duct arm or the trunk, and a screen filter member attached to one end of the duct arm or the trunk for receiving and collecting the dirt.

For example, U.S. Pat. No. 7,186,281 to Cheng discloses one of the typical dust collecting machines having a dust removing device disposed in a dust collecting tank for sweeping or removing dirt or ash from the dust collecting tank manually with two handles and a pulling unit.

However, a worker is required to hold the handles and to actuate the handles to pull the pulling unit in order to actuate or operate the dust removing device to sweep or remove the dirt or ash from the dust collecting tank such that the dust removing device for the typical dust collecting machines may not be operated automatically.

The applicant of the present invention has developed another typical vacuum collector which is allowed and issued as U.S. Pat. No. 7,318,249 to Lin and which includes a filter member disposed in a filter canister, and a sweeping device disposed in the filter member for sweeping the filter member and for removing the dirt or ash from the filter member.

However, in the typical vacuum collectors, the sweeping device is also required to be operated with a handle such that a worker is also required to hold the handle and to actuate the handle to actuate or operate the sweeping device to sweep or remove the dirt or ash from the filter member such that the filter member device for the typical vacuum collectors also may not be operated automatically.

The present invention has arisen to mitigate and/or obviate the afore-described disadvantages of the conventional vacuum collectors.

### SUMMARY OF THE INVENTION

The primary objective of the present invention is to provide a vacuum collector including a stirring or sweeping device disposed in a screen filter member and operated with a separated motor for sweeping dirt from the screen filter member and for allowing the dirt to be easily and automatically collected.

The other objective of the present invention is to provide a vacuum collector including a control device coupled to the sweeping device and the vacuum motor for selectively or alternatively or automatically actuating or operating the sweeping device and the vacuum motor.

In accordance with one aspect of the invention, there is provided a vacuum collector comprising a housing; a filter canister disposed below the housing, a filter member disposed in the filter canister, a dust removing device disposed in the filter member and disposed in the filter canister for sweeping dust from the filter member, a driving device disposed on the housing and coupled to the dust removing device for actuating the dust removing device to automatically sweep and remove the dust from the filter member, a dust collecting receptacle disposed below the housing and coupled to the housing, a fan device disposed in the housing and disposed above the dust collecting receptacle for drawing air and dust into the housing and for collecting particles in the dust collecting receptacle, and a vacuum motor disposed on the housing and coupled to the fan device for automatically drawing the air and the dust into the housing.

The dust removing device includes a shaft rotatably disposed in the filter canister, and at least one blade adjustably attached to the shaft for engaging with the filter member to sweep of the dust from the filter member when the blade is rotated relative to the filter member.

A control device may further be provided and coupled to the driving device and the vacuum motor for selectively or alternatively or automatically actuating or operating the driving device and the vacuum motor.

The control device includes a switch for selectively or alternatively actuating or operating the driving device and the vacuum motor. The control device includes a plug for electrically coupling to a power source.

A base may further be provided and includes a post extended upwardly therefrom, the housing being disposed on the post. The base includes an opening formed in the base for slidably receiving the dust collection receptacle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a vacuum collector in accordance with the present invention;

FIG. 2 is a partial perspective view illustrating the filter device for the vacuum collector;

FIG. 3 is a partial cross sectional view of the filter device for the vacuum collector taken along lines 3-3 of FIG. 2; and

FIG. 4 is a partial cross sectional view similar to FIG. 3, illustrating the operation of the filter device for the vacuum collector.

### DETAILED DESCRIPTION OF THE PREFERRED EMBODIMENT

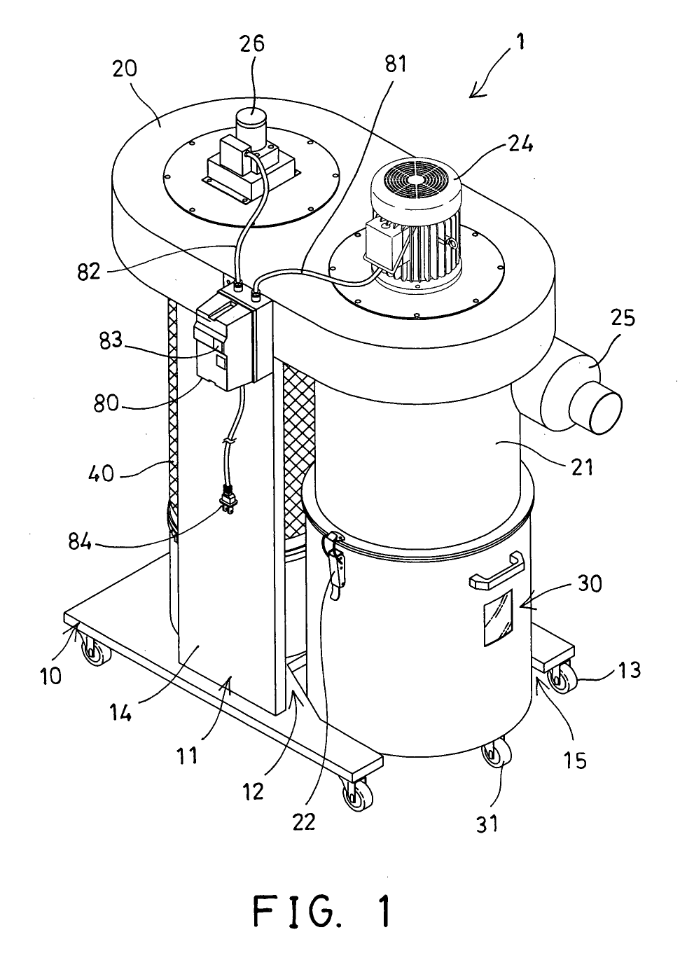

Referring to the drawings, and initially to FIG. 1, a vacuum collector 1 in accordance with the present invention comprises a base 10 including an upright support or post 11 extended upwardly therefrom, and including a chamber 12 formed in the post 11 and defined by such as two side panels 14, and including an opening 15 formed in the base 10 for slidably receiving a dust collection barrel or dust collecting receptacle 30, the dust collecting receptacle 30 may include two or more wheels 31 attached to the bottom thereof for moving the dust collecting receptacle 30 away from or toward the base 10, and the base 10 may also include two or more wheels 13 attached to the bottom thereof for moving the base 10 to any suitable positions or locations.

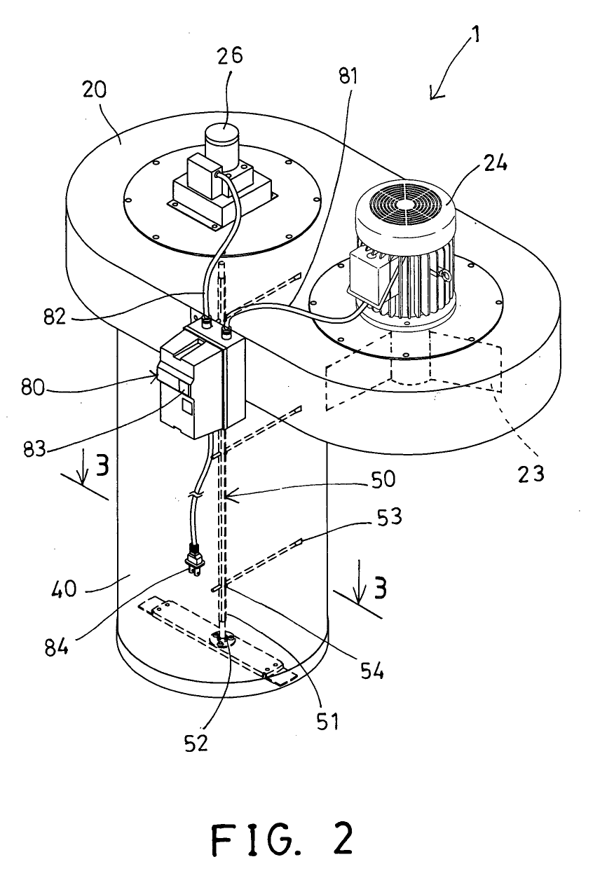

The vacuum collector 1 further includes a housing 20 disposed on top of the post 11 and having a duct 22 attached to or extended downwardly from the housing 20, the duct 22 is arranged or disposed above the dust collecting receptacle 30 and selectively coupling or locking or securing to the dust collecting receptacle 30 with one or more locking or latching devices 22, such as the quick-release locking or latching devices 22 for selectively locking or securing the dust collecting receptacle 30 to the housing 20, and for selectively closing the dust collecting receptacle 30 and for allowing the dust collecting receptacle 30 to be selectively removed or disengaged from the housing 20 and the base 10. A fan device 23 is disposed or engaged into the housing 20 (FIG. 2) and preferably arranged or disposed above the duct 22 for air drawing or vacuuming purposes.

For example, an electric vacuum motor or pump 24 is disposed or attached to the upper portion of the housing 20 and coupled to the fan device 23 for rotating or driving the fan device 23 to vacuum or to draw the dust or dirt or fume into the housing 20. For example, the housing 20 includes a hose or inlet port 25 (FIG. 1) for coupling to trunks or duct arms or nozzles (not shown) or the like, and for directing toward the dust or dirt or fume to be collected, in order to vacuum or to drawn the dust or the dirt or the fume through the hose or inlet port 25 and then into the housing 20. The larger dirt or particles may be dropped into and collected within the dust collecting receptacle 30. As shown in FIGS. 1 and 2, a filter canister 40 may further be provided and disposed below the housing 20 and attached or coupled to the lower portion of the housing 20 and communicating with the housing 20 for receiving and collecting the light weight dust or dirt.

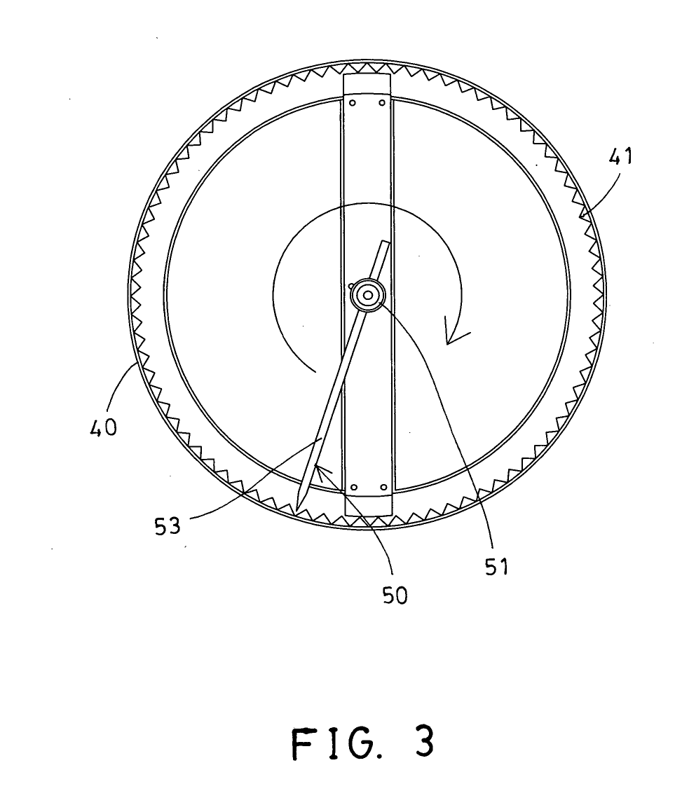

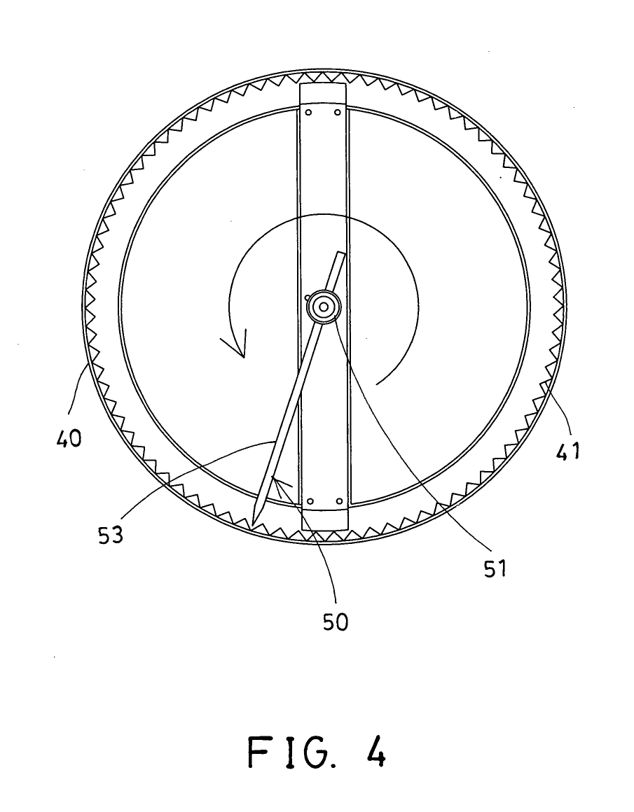

Another motor or motor driving device 26, such as a step motor 26 may further be provided and attached or disposed on the housing 20, and preferably arranged or disposed above the filter canister 40, and coupled to a stirring or sweeping or dust removing device 50 which is disposed in a filter member 41 (FIGS. 3, 4) that is also disposed in the filter canister 40 for sweeping the dust or the dirt from the filter member 41 and for allowing the dust or the dirt to be easily removed from the filter member 41 and/or to be easily collected within the filter member 41, in which the dust removing device 50 has been disclosed and filed and claimed in the co-pending U.S. Pat. No. 7,318,249 to Lin which may be taken as a reference for the present invention.

For example, the dust removing device 50 includes a shaft 51 rotatably disposed in the filter member 41 and in the filter canister 40, and the shaft 51 includes two ends rotatably secured to the filter canister 40 with such as seats or bearings 52 or the like, and one or more flaps or blades 53 adjustably secured or attached to the shaft 51 with such as a fastener 54 (FIG. 2) for allowing the blades 53 to be adjusted toward and away from the filter member 41 and to be suitably engaged with the filter member 41 and thus for suitably sweeping and removing the dust or the dirt from the filter member 41. The step motor or motor driving device 26 is coupled to the shaft 51 for driving or rotating the shaft 51 and the blades 53 to engage with and to sweep and remove the dust or the dirt from the filter member 41.

The vacuum collector 1 may further include a control device 80 electrically coupled to the vacuum motor or pump 24 and the motor driving device 26 with electric wires or cables 81, 82 (FIGS. 1, 2) respectively, and a switch 83 for selectively actuating or operating the vacuum motor or pump 24 and the motor driving device 26, and an electric coupler or plug 84 electrically coupled to the control device 80 for selectively and electrically coupling the control device 80 to the electric reservoir or power source (not shown) and thus for allowing the vacuum motor or pump 24 and the motor driving device 26 to be suitably and selectively actuated or operated with the control device 80. It is preferable that the shaft 51 and the blades 53 may be selectively or changeably rotated in either direction (FIGS. 3, 4) by the motor driving device 26.

In operation, when the electric coupler or plug 84 is electrically coupled to the power source, for example, the motor driving device 26 may be energized or operated to actuate or to rotate the shaft 51 and the blades 53 of the dust removing device 50 in either or both directions for such as one minute and to suitably sweep and remove the dust or the dirt from the filter member 41. At this moment, the switch 83 is not required to be depressed or actuated, and the vacuum motor or pump 24 and the fan device 23 are not energized or operated.

When the switch 83 is depressed or actuated once, for example, the motor driving device 26 may be switched off and the vacuum motor or pump 24 may be energized or operated to actuate the fan device 23 for few minutes or for a predetermined time interval in order to draw the air and the dust or dirt or fume through the inlet port 25 and then into the housing 20 and/or for vacuuming purposes and thus for collecting the larger dirt or particles within the dust collecting receptacle 30 and for drawing and collecting the light weight dust or dirt into the filter canister 40. At this moment, the shaft 51 and the blades 53 of the dust removing device 50 are not operated by the motor driving device 26.

When the switch 83 is depressed or actuated again, for example, the vacuum motor or pump 24 may be switched off and the motor driving device 26 may be energized or operated to actuate or to rotate the shaft 51 and the blades 53 of the dust removing device 50 in either or both directions for such as one minute and to suitably sweep and remove the dust or the dirt from the filter member 41 again. At this moment, the vacuum motor or pump 24 and the fan device 23 are not energized or operated. The vacuum motor or pump 24 and the motor driving device 26 may be switched off when the switch 83 is depressed or actuated again, for example.

Alternatively, the vacuum motor or pump 24 and the motor driving device 26 may be automatically and alternatively energized or operated or actuated by the control device 80 without depressing or actuating the switch 83 when the electric coupler or plug 84 is electrically coupled to the power source, for example, and the vacuum motor or pump 24 and the motor driving device 26 may be switched off when the switch 83 is depressed or actuated by the user such that the dust removing device 50 is not required to be operated manually.

Accordingly, the vacuum collector in accordance with the present invention includes a stirring or sweeping device disposed in a screen filter member and operated with a separated motor for sweeping dirt from the screen filter member and for allowing the dirt or the ash to be easily and automatically collected, and includes a control device coupled to the sweeping device and the vacuum motor for selectively or alternatively or automatically actuating or operating the sweeping device and the vacuum motor.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A vacuum collector comprising:
a housing;
a filter canister disposed below said housing,
a filter member disposed in said filter canister,
a dust removing device disposed in said filter member and disposed in said filter canister for sweeping dust from said filter member,
a driving device disposed on said housing and coupled to said dust removing device for actuating said dust removing device to sweep and remove the dust from said filter member,
a dust collecting receptacle disposed below said housing and coupled to said housing,
a fan device disposed in said housing and disposed above said dust collecting receptacle for drawing air and dust into said housing and for collecting particles in said dust collecting receptacle, and
a vacuum motor disposed on said housing and coupled to said fan device for drawing the air and the dust into said housing.

2. The vacuum collector as claimed in claim 1, wherein said dust removing device includes a shaft rotatably disposed in said filter canister, and at least one blade attached to said shaft for engaging with said filter member to sweep of the dust from said filter member when said at least one blade is rotated relative to said filter member.

3. The vacuum collector as claimed in claim 1 further comprising a control device coupled to said driving device and said vacuum motor for selectively actuating or operating said driving device and said vacuum motor.

4. The vacuum collector as claimed in claim 3, wherein said control device includes a switch for selectively actuating or operating said driving device and said vacuum motor.

5. The vacuum collector as claimed in claim 3, wherein said control device includes a plug for electrically coupling to a power source.

6. The vacuum collector as claimed in claim 1 further comprising a base including a post extended upwardly therefrom, said housing being disposed on said post.

7. The vacuum collector as claimed in claim 6, wherein said base includes an opening formed in said base for slidably receiving said dust collection receptacle.
